(19) United States
(12) Patent Application Publication
(10) Pub. No.: US 2007/0176025 A1
(43) Pub. Date: Aug. 2, 2007

(54) Corrosion resistant magnetic component for a fuel injection valve

(76) Inventor: Joachim Gerster, Alzenau (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/343,558

(22) Filed: Jan. 31, 2006

(51) Int. Cl. F02M 63/00

(52) U.S. Cl. 239/533.2

(57) ABSTRACT

A magnetic component for a magnetically actuated fuel injection device is formed of a corrosion resistant soft magnetic alloy consisting essentially of, in weight percent, 3%<Co<20%, 6%<Cr<15%, 0%≦S≦0.5%, 0%≦Mo≦3%, 0%≦Si≦3.5%, 0%≦Al≦4.5%, 0%≦Mn≦4.5%, 0%≦Me≦6%, where Me is one or more of the elements Sn, Zn, W, Ta, Nb, Zr and Ti, 0%≦V≦4.5%, 0%≦Ni≦5%, 0%≦C<0.05%, 0%≦Cu<1%, 0%≦P<0.1%, 0%≦N<0.5%, 0%≦0<0.05%, 0%≦B<0.01%, and the balance being essentially iron and the usual impurities.

### TECHNICAL FIELD

The invention relates to a corrosion resistant magnetic component, and in particular to a magnetic component for use in a magnetically actuated fuel injection valve which operates in a corrosive environment.

### BACKGROUND

Magnetically actuated devices, such as solenoid valves are used in many types of systems including automotive applications such as fuel injection, anti-lock braking and active suspension systems.

Magnetically actuated devices typically include a magnetic coil and a moving magnetic core or plunger. In a typical arrangement of a solenoid valve 10, as shown in FIG. 1, the coil 22 surrounds the plunger 28 such that when the coil 22 is energized with electric current, a magnetic field is induced in the interior of the coil 22. The plunger 28 is formed of a soft magnetic material, typically a ferritic steel. A spring (not shown) holds the plunger 28 in a first position such that the device is either normally open or closed. When the coil 22 is energized, the induced magnetic field causes the plunger 28 to move to a second position to either close the device, if it is normally open, or open it, if it is normally closed.

It is desirable that the material used to make the magnetic core have good soft magnetic properties, principally, a low coercive field strength to minimize “sticking” of the component and a high saturation induction to minimize the size and weight of the component.

The plunger is often in direct contact with the local environment such as the fluid that is being controlled. Many environments and fluids are corrosive and will corrode the plunger, which may cause the device to malfunction or the valve to leak or become inoperative. It is, therefore, desirable that the plunger be formed of a material that has good resistance to the corrosive influence of the environment in which it is to be used.

The increasingly frequent use of magnetically actuated valves in automotive technologies as fuel injection systems has created a need for a magnetic material having improved corrosion resistance. The need for better corrosion resistance is of particular importance in automotive fuel injection systems in view of the introduction of more corrosive fuels such as those containing ethanol or methanol.

It is known to use ferritic steels for the magnetic component of fuel injection valves, but the corrosion resistance has been found to be insufficient in corrosive fuel environments.

### SUMMARY

It is, therefore, an object of the invention to provide a magnetic component for a magnetically actuated fuel injection device which is suitable for use in corrosive fuel environments and, in particular, methanol-containing or ethanol-containing fuel mixtures.

It is also desirable that the magnetic component has a saturation induction, a coercive field strength and an electrical resistivity which are sufficient for future requirements, in particular, for the fine control required by future fuel injection systems in order that the engine fulfils future environmental emissions legislation.

Additionally, it is desirable that the magnetic component is easily machined so that manufacturing costs are not increased and the components can be manufactured with the required tolerances and surface finish.

According to the invention, a magnetic component for a magnetically actuated fuel injection device is provided. The magnetic component is formed of a corrosion resistant soft magnetic alloy consisting essentially of, in weight percent, 3%<Co<20%, 6%<Cr<15%, 0%≦S≦0.5%, 0%≦Mo≦3%, 0%≦Si≦3.5%, 0%≦Al≦4.5%, 0%≦Mn≦4.5%, 0%≦Me≦6%, where Me is one or more of the elements Sn, Zn, W, Ta, Nb, Zr and Ti, 0%≦V≦4.5%, 0%≦Ni≦5%, 0%≦C<0.05%, 0%≦Cu<1%, 0%≦P<0.1%, 0%≦N<0.5%, 0%≦0<0.05%, 0%≦B<0.01%, and the balance being essentially iron and the usual impurities.

The magnetic component according to the invention has excellent corrosion resistance in corrosive fuel environments and soft magnetic properties suitable for a magnetically actuated fuel injection valve, in particular a high saturation polarization, Jₛ, low coercive field strength, H_{c}, and a high resistivity, ρ. The magnetic component also has good machining properties.

In this description, all compositions are given in weight percent, wt %.

In further embodiments of the invention, the Co-content of the magnetic component lies in the ranges 6%<Co <16% or 10.5%<Co<18.5%. For applications in which a high Jₛ is desirable, a higher Co content may be provided. Since Cobalt is a relatively expensive element, it may desirable to use a lower cobalt content for applications in which it is desired to reduce the materials cost.

The alloy may contain 0.01%≦Mn≦1% and 0.005%≦S≦0.5% or 0.01%≦Mn≦0.1% and 0.005%≦S≦0.05%. In a further embodiment, the ratio of manganese to sulphur, Mn/S, is ≧1.7. The provision of manganese and sulphur additions within these ranges further improves the free machining properties of the alloy. The alloy may comprise Titanium in the place of manganese and, therefore, may contain 0.01%≦Ti≦1% by weight. Ti also improves the free machining properties of the alloy and has the additional advantage that it improves the magnetic properties and corrosions resistance of the alloy.

The sum of Cr and Mo may lie in the range 11%≦Cr+Mo≦19% and in a further embodiment, the sum of Si+1.3Al +1.3Mn+1.7Sn+1.7Zn+1.3V≦3.5%.

The polarization J of the magnetic component at a magnetic field H of 160 A/cm may be greater than 1.6 T or greater than 1.7 T. The saturation polarization Jₛ of the magnetic component at a magnetic field H of 600 A/cm may be greater than 1.75 T or greater than 1.8 T. A high value of the saturation polarization Jₛ enables the size and weight of the magnetic component to be reduced.

The magnetic component may have an electrical resistivity, ρ, which is greater than 0.4 μΩm or greater than 0.5 μΩm or greater than 0.58 μΩm. A higher value of resistivity, ρ, leads to a reduction in eddy currents after the magnetic field is applied or removed to the magnetic component. Damping of the eddy currents improves the responsiveness of the device. This can be advantageously used in optimization of the control of the fuel injection device at high engine revolutions.

The fuel injection device, according to the invention, may be used in a gasoline engine or a diesel engine. In this context, gasoline engine is used to denote an engine designed to operate with a gasoline fuel supply and diesel engine is used to denote an engine designed to operate with a diesel fuel supply.

The fuel injection site and the environment under which the fuel injection device operates, for example pressure and engine revolutions, is different in gasoline engines and diesel engines. The corrosiveness of the environment in which the magnetic component of the fuel injection device operates may, therefore, differ in addition to the desired magnetic and electrical properties of the magnetic component. Therefore, the composition most suitable for a fuel injection device for a gasoline engine and the composition most suitable for a fuel injection device for a diesel engine may differ although both compositions lie within the ranges of the invention. In a further embodiment, the fuel injection device is a direct fuel injection valve.

In an embodiment of the invention, the magnetic component is for use in an environment comprising a mixture of fuel and an alcohol, wherein the fuel is one of gasoline and diesel. Fuel mixtures including an alcohol are known to be extremely corrosive. These fuel mixtures may also comprise a small quantity of water in a form commonly described as corrosive water.

In further embodiments, the mixture comprises 90% gasoline and 10% alcohol or 85% gasoline and 15% alcohol or 80% gasoline and 20% alcohol.

The alcohol may comprise methanol, ethanol, propanol, butanol or a mixture of two or more of methanol, ethanol, propanol and butanol.

Fuel mixtures of gasoline and alcohol are often found to be more corrosive than fuel mixtures of diesel and alcohol. Consequently, a composition particularly suitable for use in a gasoline/alcohol fuel mixture environment and a composition particularly suitable for use in a diesel/alcohol fuel mixture environment may differ although both compositions lie within the ranges defined by the invention.

In an embodiment, the alcohol is methanol. In further embodiments, the mixture comprises 90% gasoline and 10% methanol or 85% gasoline and 15% methanol or 80% gasoline and 20% methanol.

In an embodiment, the alcohol is ethanol. In further embodiments, the mixture comprises 90% gasoline and 10% ethanol or 85% gasoline and 15% ethanol or 80% gasoline and 20% ethanol.

Similarly, fuel mixtures of gasoline and methanol or ethanol are often found to be more corrosive than fuel mixtures of diesel and methanol or ethanol. For example, a composition particularly suitable for use in a gasoline/methanol fuel mixture environment and a composition particularly suitable for use in a diesel/methanol fuel mixture environment may differ although both compositions lie within the ranges defined by the invention.

### BRIEF DESCRIPTION OF THE DRAWINGS

FIG. 1 Schematic diagram of a magnetically actuated solenoid valve known in the art,

FIG. 2 Graph showing coercive field strength H_{c} as a function of annealing temperature,

FIG. 3 Graph showing polarization J as a function of magnetic field H for unannealed samples,

FIG. 4 Graph showing polarization J as a function of magnetic field H for samples annealed at 500° C. for 5 hours,

FIG. 5 Graph showing polarization J as a function of magnetic field H for samples annealed at 550° C. for 5 hours,

FIG. 6 Graph showing polarization J as a function of magnetic field H for samples annealed at 600° C. for 5 hours,

FIG. 7 Graph showing polarization J as a function of magnetic field H for samples annealed at 650° C. for 5 hours,

FIG. 8 Graph showing polarization J as a function of magnetic field H for samples annealed at 700° C. for 5 hours,

FIG. 9 Graph showing polarization J as a function of magnetic field H for samples annealed at 800° C. for 5 hours.

FIG. 10 Graph showing polarization J as a function of magnetic field H for samples annealed at 900° C. for 5 hours,

FIG. 11 Graph showing polarization J as a function of magnetic field H for samples annealed at 1000° C. for 5 hours,

FIG. 12 Graph showing polarization J₁₆₀ at a magnetic field H of 160 A/cm as a function of annealing temperature, and

FIG. 13 Graph showing saturation polarization J₆₀₀ at a magnetic field H of 600 A/cm as a function of annealing temperature.

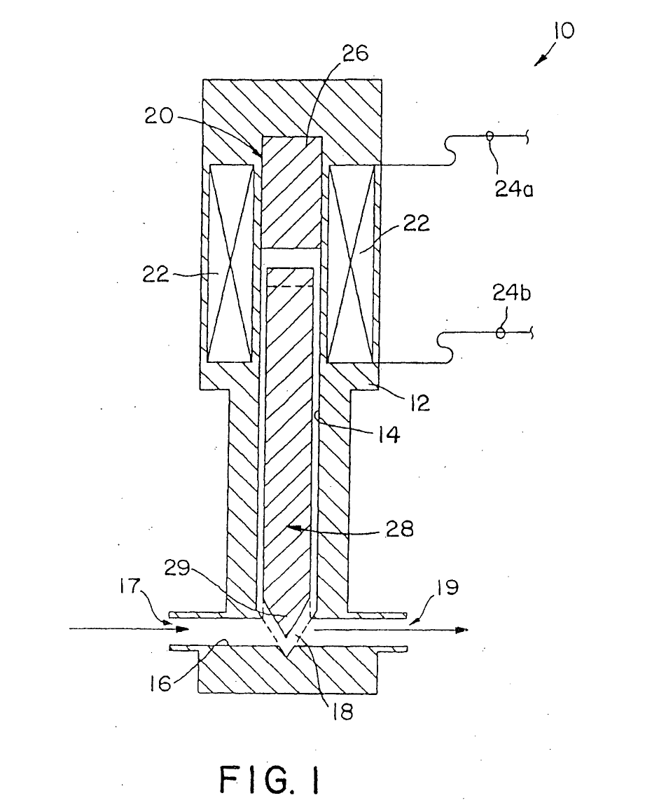

Table 1 Table showing the composition of the batches of alloys according to the invention.

Table 2 Table showing coercive field strength, H_{c}, as a function of annealing temperature

Table 3 Table showing the electrical resistivity, ρ, measured for samples with different Co-contents.

Table 4 Table showing a comparison of the magnetic and electrical parameters of the alloys according to the invention and commercially available alloys.

Table 5 Table showing the results of corrosion tests at 85° C. and 85% humidity.

Table 6 Table showing the results of corrosion tests in a gasoline/methanol/corrosive water solution.

Table 7 Table showing results of corrosion tests in a sulphate, nitrate and chloride-containing solution.

### DETAILED DESCRIPTION

Five FeCrCo-based alloys of differing composition were fabricated by melting and casting 5 kg of each composition. Each alloy comprised 13 wt % chromium and the cobalt content was varied from 0 wt % to 20 wt %. The composition of each of the five batches is listed in Table 1.

Each of the cast blocks was turned to a diameter of 40 mm. The blocks were heated to a temperature of 1200° C. and then hot rolled to a diameter of approximately 12 mm. The samples were then etched in hydrochloric acid and aqua regia.

Each sample was swaged from a diameter of 12 mm to a diameter in the range of 10.47 mm to 10.66 mm. The rods were then degreased and cold-drawn to a diameter of 10 mm. From each of these rods, ten measurement samples, each with a length of 100 mm, were cut for annealing experiments and magnetic measurements. From each alloy composition, a measurement sample was annealed at a temperature between 500° C. and 1150° C. in a hydrogen atmosphere for five hours.

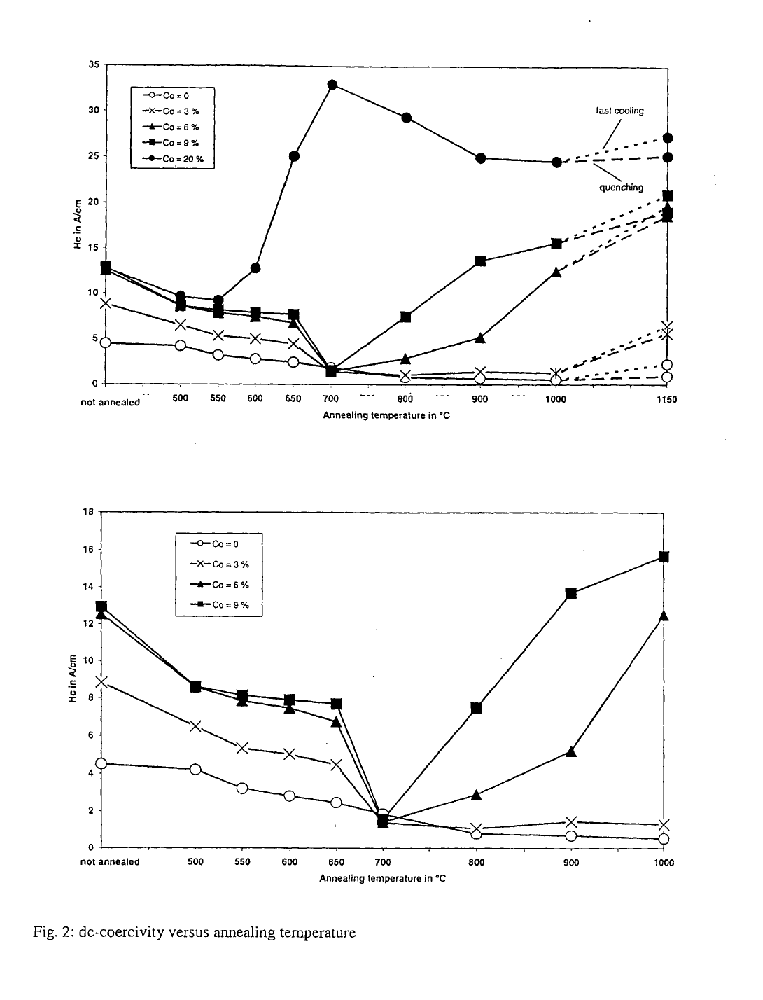

The coercive field strength H_{c} (A/cm) was measured for each of the compositions and annealing temperatures and the results are summarized in Table 2 and FIG. 2.

A low value of H_{c} is desired for the magnetic component of magnetically actuated devices. H_{c} is inversely proportional to the permeability, μ. A high permeability leads to a reduction in the electric current required to achieve a given flux density. A low value of H_{c} permits rapid magnetization and demagnetization and enables the valve to be quickly opened and closed. This is particularly desirable in fuel injection systems and in particular for fuel injection systems for petrol motors where the rpm of the engine is high.

As can be seen in Table 2 and FIG. 2, for samples with 0 wt % to 9 wt % Co, the coercive field strength, H_{c}, was observed to decrease with increasing annealing temperature and the lowest value is reached at around 700° C. For annealing temperatures of above 700° C., the coercive field strength, H_{c}, was found to increase by a different amount depending on the cobalt content. For temperatures above 700° C., the coercive field strength of the alloy without cobalt reduces further whereas, for the Co-containing samples, H_{c} was observed to increase with increasing Co-content.

However, the batch with a Cobalt content of 20 wt % shows a different type of behavior. For this composition, the lowest value of the coercive field strength, H_{c}, was reached at an annealing temperature of 550° C. For higher annealing temperatures, the coercive field strength, H_{c}, increases to over 30 A/cm after annealing at 700° C. and then decreases again with increasing temperature for annealing temperatures between 700° C. and 1000° C.

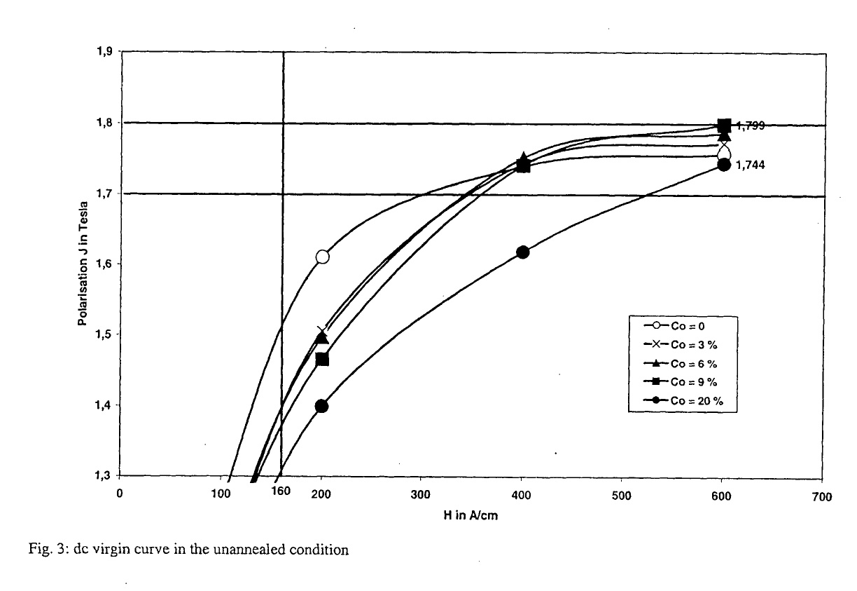

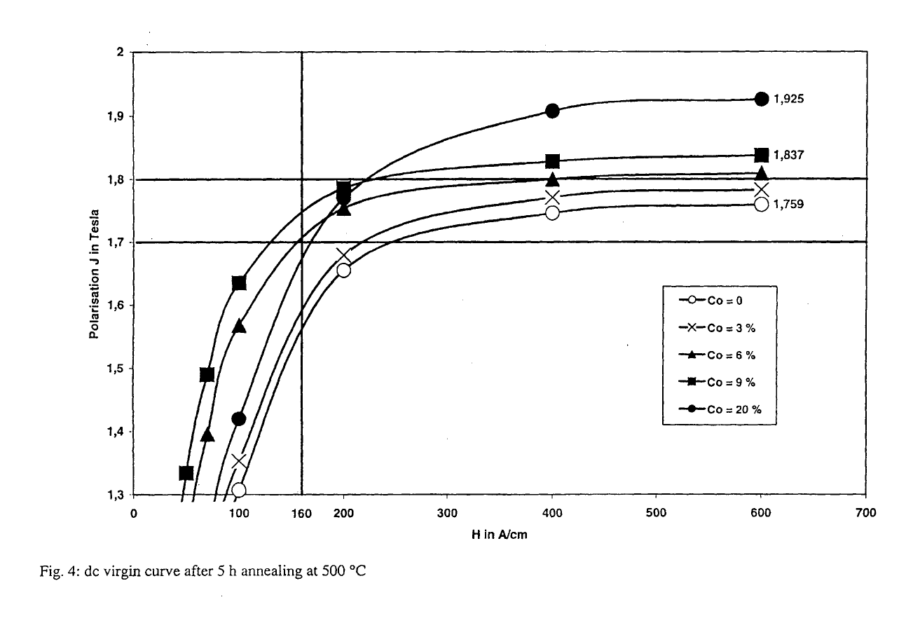

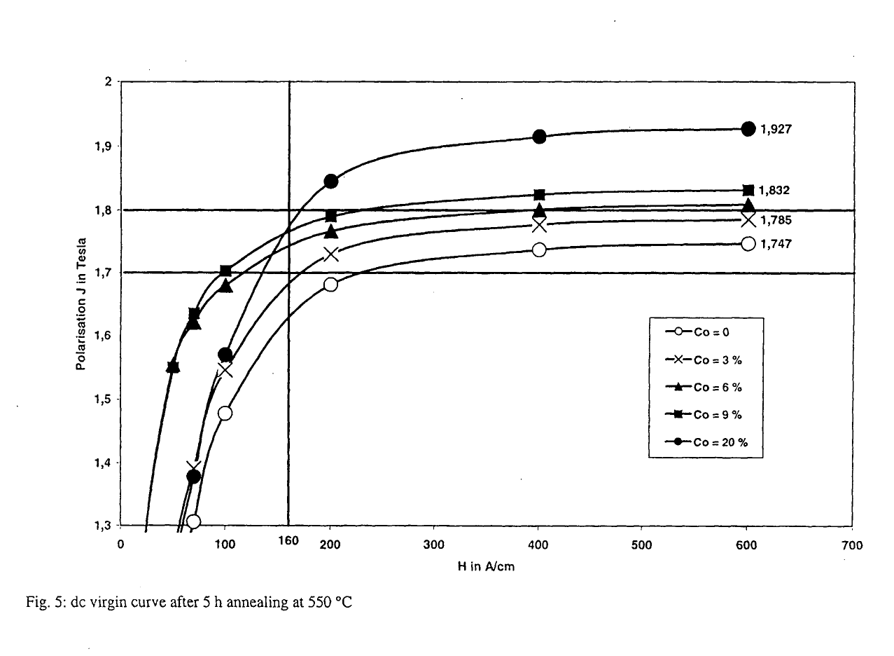

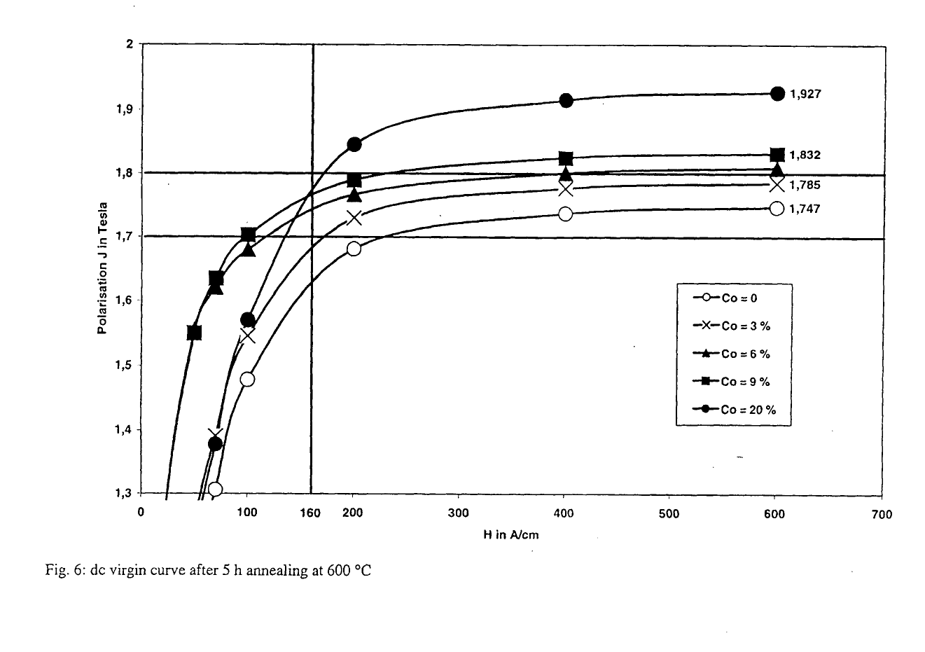

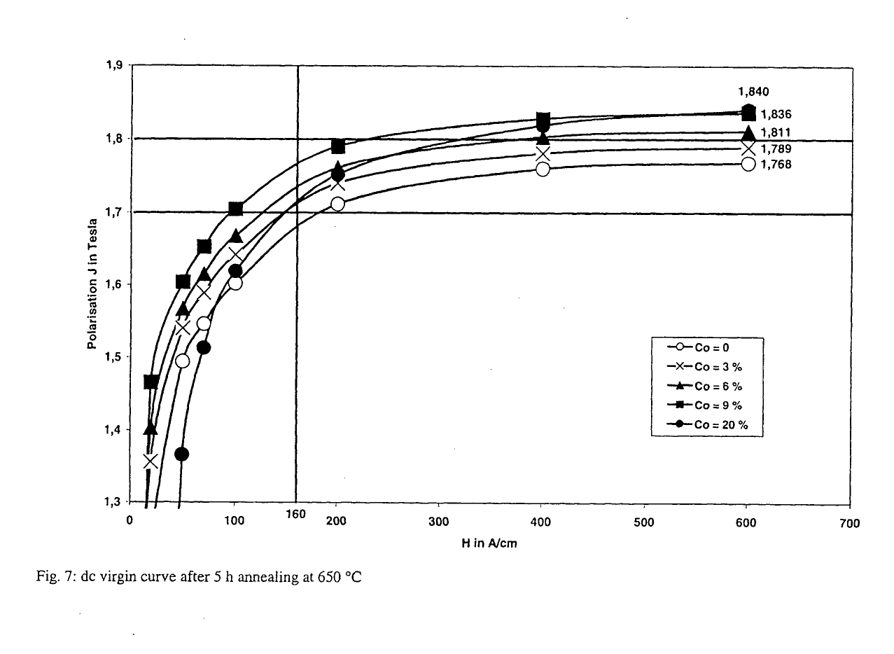

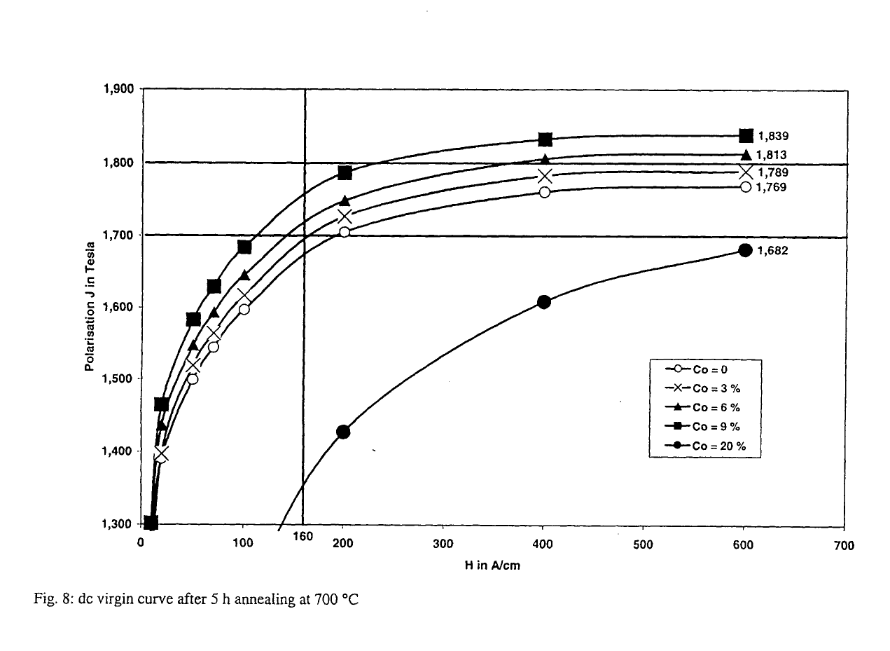

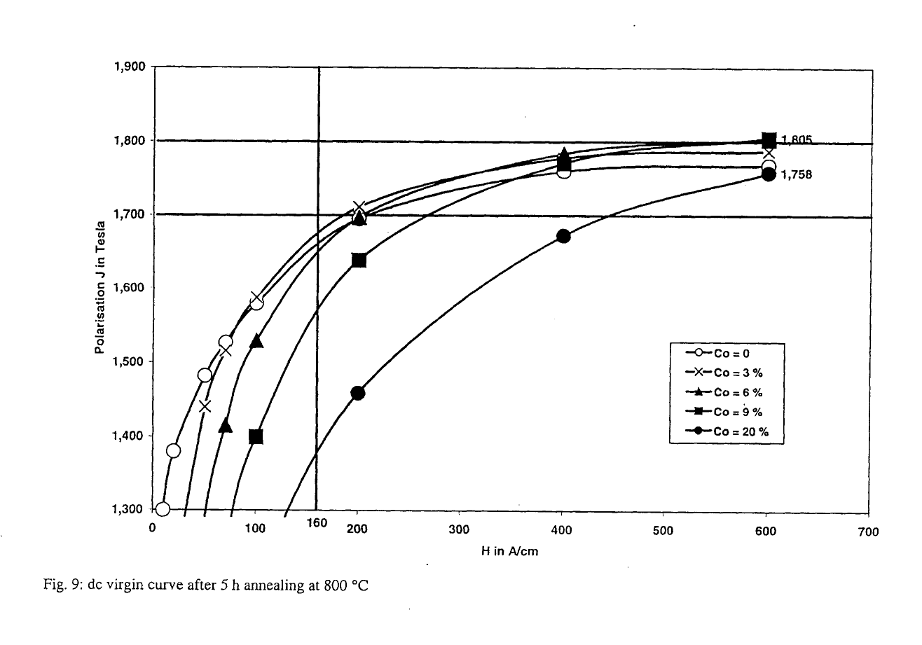

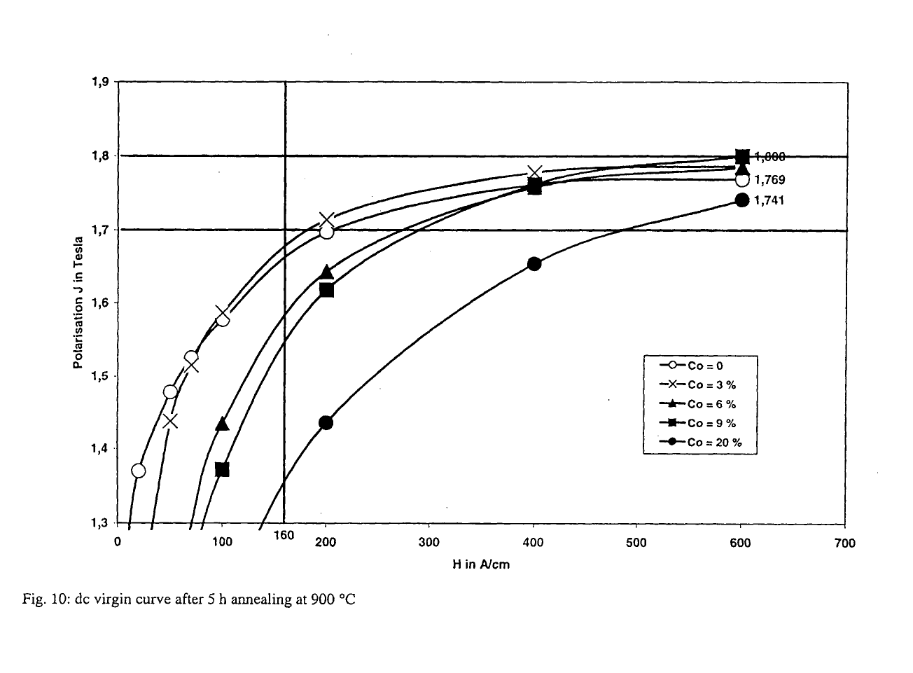

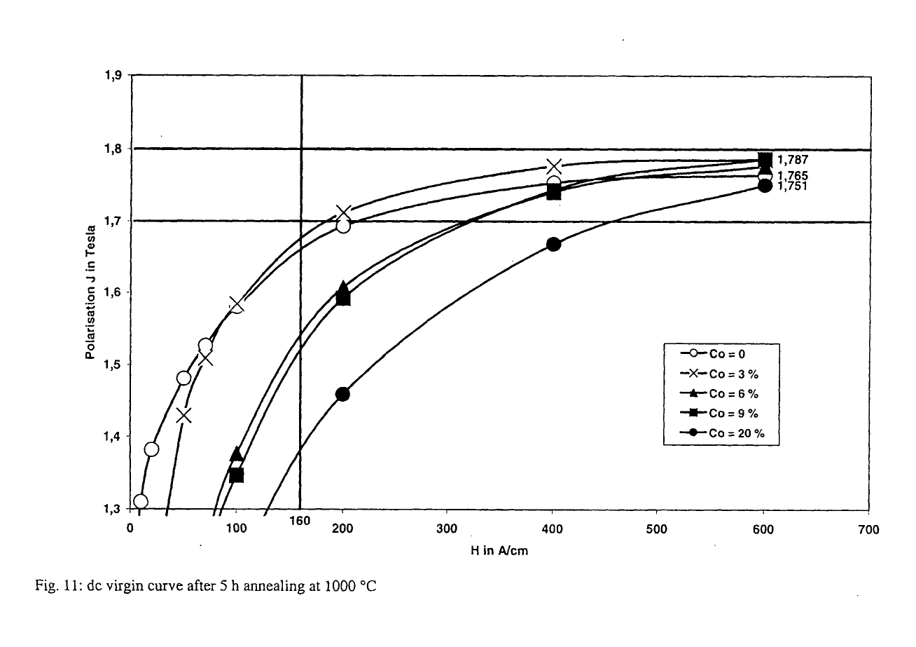

The polarization J for applied magnetic fields H of up to 600 A/cm was measured for samples of each of the compositions and each of the annealing temperatures. The results of these experiments are shown in FIGS. 3 to 11.

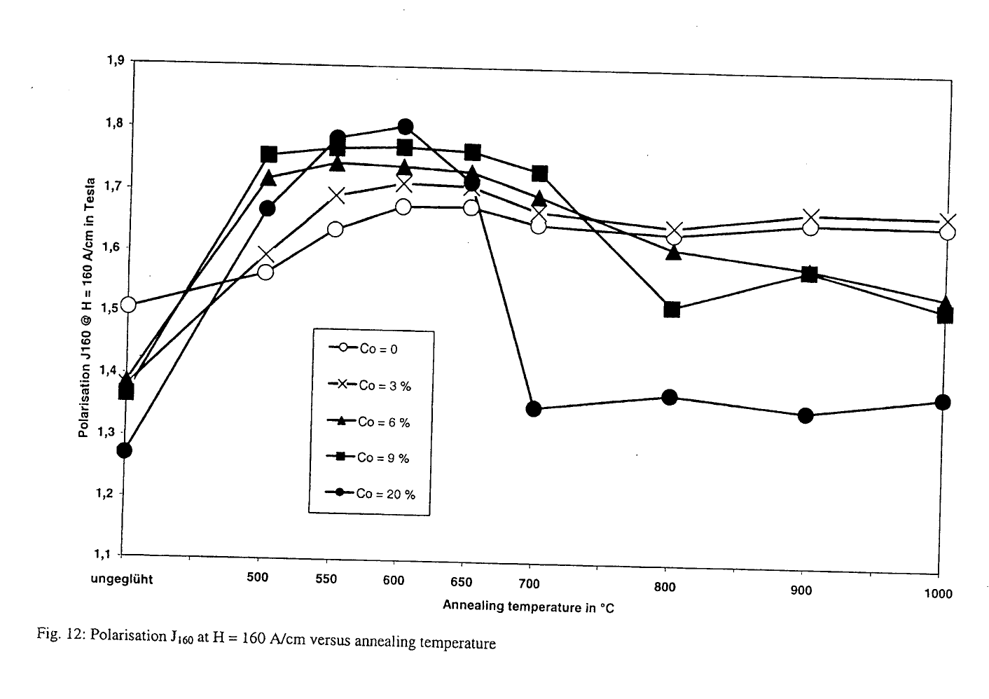

The relationship between the polarization at a measurement magnetic field of 160 A/cm (J₁₆₀) and the annealing temperature is summarized in FIG. 12 for each of the alloy compositions.

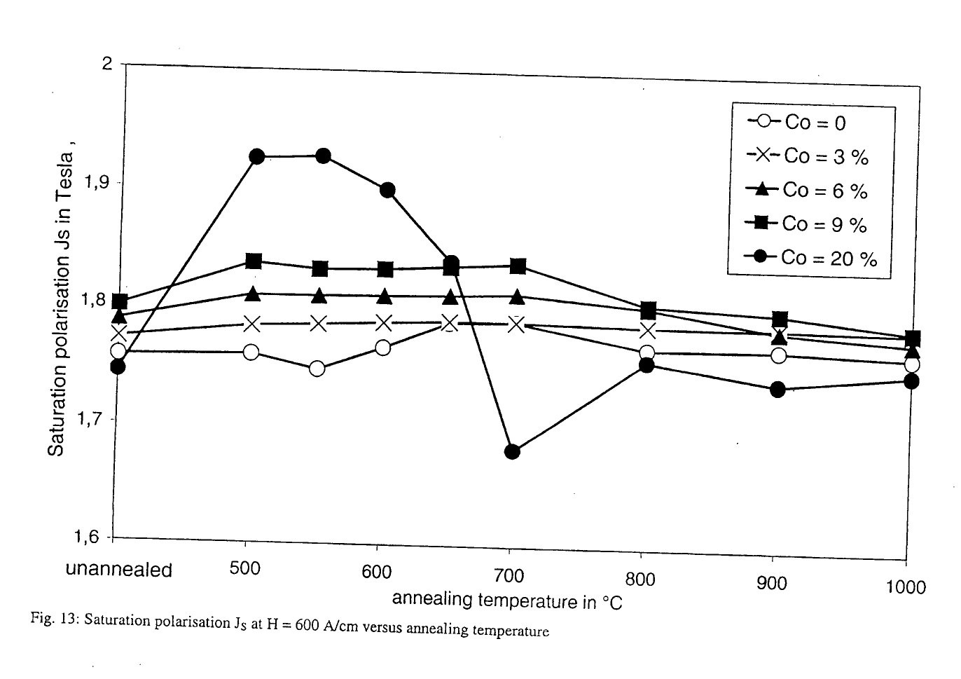

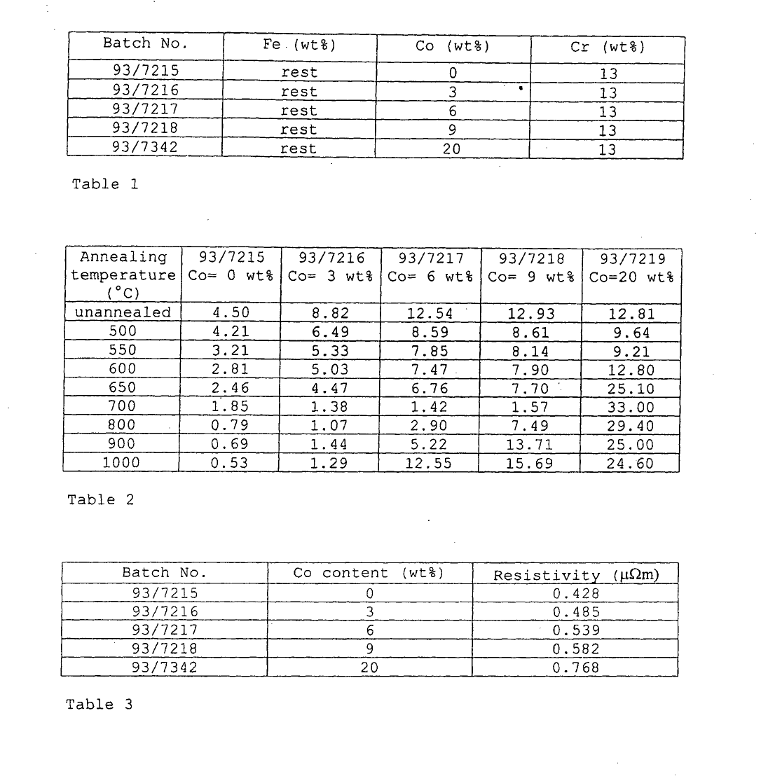

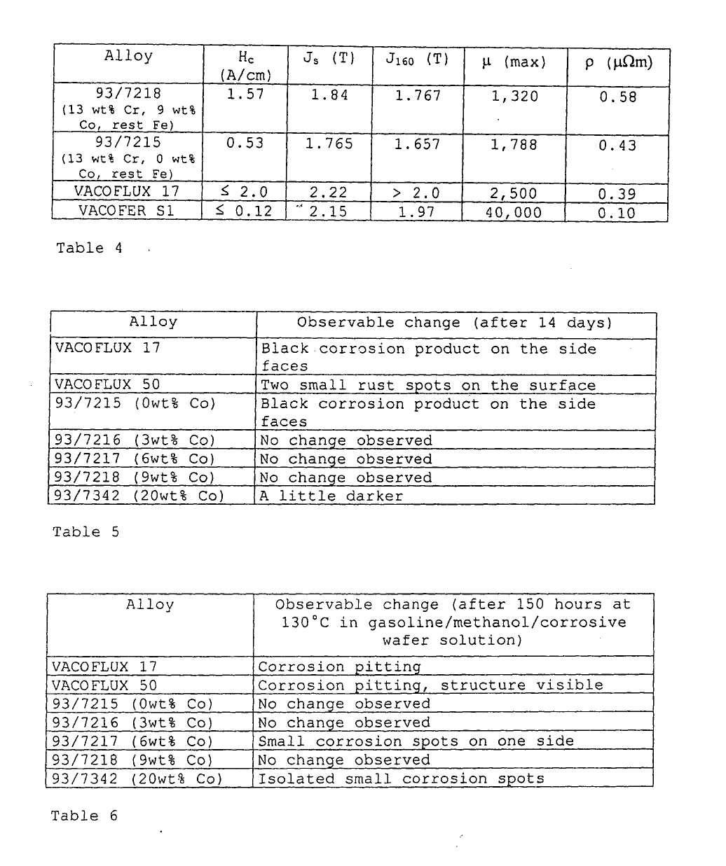

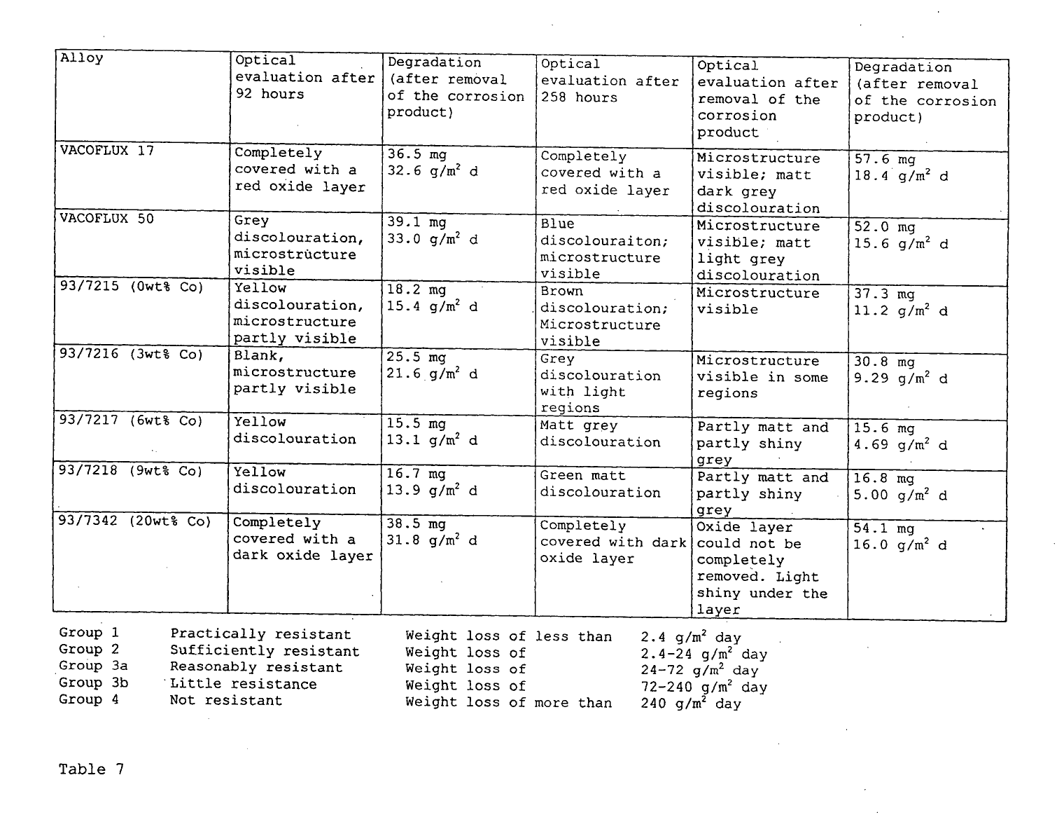

The relationship between the saturation polarization Jₛ at a measurement magnetic field of 600 A/cm (J₆₀₀) and the annealing temperature is summarized in FIG. 13 for each of the alloy compositions.

A high value of Jₛ is desirable so that the size and weight of the magnetic component may be reduced. For a magnetic field of 160 A/cm, a value of J₁₆₀ of above 1.7 T is observed for the alloys with a cobalt content of 6 wt % and 9 wt % and an annealing temperature of 650° C. and 700° C.

The electrical resistivity, ρ, was also measured for each of the batches and is shown in Table 3. It is desirable that the electrical resistivity be as high as possible to dampen eddy currents and improve the responsiveness of the device. The resistivity, ρ, was measured to increase from 0.428 μΩm for the alloy containing 0 wt % cobalt to 0.768 μΩm for the alloy containing 20 wt % cobalt.

The alloy comprising 9 wt % Co, 13 wt % Cr, rest Fe showed the best soft magnetic characteristics for annealing conditions of 700° C. for five hours. The highest saturation polarization value, Jₛ, also the polarization at a field of 160 A/cm, J₁₆₀, was also attained for this composition and the coercive field strength, H_{c}, which lies at 1.57 A/cm is also reasonably low. The resistivity is increased to 0.582 μΩm which is advantageous for the dynamics of fuel injection valves.

Table 4 compares the values of H_{c}, Jₛ, J₁₆₀, μ and ρ for a composition of 13 wt % Cr, 9 wt % Co, rest Fe with the composition 0 wt % Co, 13 wt % Cr, rest Fe, commercially available pure Fe (VACOFER™ S1) and a commercially available FeCo alloy (VACOFLUX® 17) of composition 17 wt % Co, 2 wt % Cr, 1 wt % Mo, rest Fe.

As shown in Table 4, an alloy comprising 9 wt % Co, 13 wt % Cr, rest Fe has a value of saturation polarization at a field of 160 A/cm, J₁₆₀, which is approximately 0.1 T higher than that observed for a binary alloy comprising 13 wt % Cr, rest Fe. The resistivity is also increased by around 0.15 μΩm over that measured for the binary alloy comprising 13 wt % Cr, rest Fe.

The composition of 9 wt % Co, 13 wt % Cr, rest Fe has a higher resistivity, but a slightly lower H_{c}, Jₛ and J₁₆₀ compared to pure Fe. However, as will be seen in the results from the corrosion experiments, the corrosion resistance of the 13 wt % Cr, 9 wt % Co, rest Fe is significantly improved over that of pure Fe.

The corrosion resistance of the five batches in addition to two commercially available alloys (VACOFLUX® 17 and VACOFLUX® 50 (49 wt % Co, 2 wt % V, rest Fe)) were investigated. In a first test, pieces of each batch were subjected to an environmental test at 85° C. and 85% humidity. The results of observational examination are summarized in Table 5.

After 14 days exposure, the alloys with cobalt contents of between 3 wt % and 9 wt % did not show any signs of corrosion.

The corrosion behavior of the alloys was also investigated for a gasoline/methanol/water environment. A solution comprising 84.5% gasoline, 15% methanol and 0.5% corrosive water was prepared. The corrosive water comprised 16.5 mg of sodium chloride per litre, 13.5 mg of sodium hydrogen carbonate per litre, and 14.8 mg of Formic acid. The samples were immersed in the solution for 150 hours at 130° C. The results of this test are shown in Table 6. The tests were optically observed under an optical microscope at a magnification of 16 times. Samples with 0 wt %, 3 wt % and 9 wt % cobalt respectively were not observed to show any signs of corrosion.

In a third corrosion test, samples were immersed in a sulphate, nitrate and chloride containing-solution. The solution comprises 1000 ppm sulphates, 500 ppm nitrates, 100 ppm chlorides and has a pH of 1.6. The samples were immersed in the solution for 11 days at 60° C. The results of this test are shown in Table 7.

As can be seen from Table 7, samples with 6 wt % cobalt and 9 wt % cobalt fulfilled the criterion of group 2 and are denoted as sufficiently corrosive resistant.

What is claimed is:

1. A magnetic component for a magnetically actuated fuel injection device, the magnetic component being formed of a corrosion resistant soft magnetic alloy consisting essentially of, in weight percent, 3%<Co<20%, 6%<Cr<15%, 0%≦S≦0.5%, 0%≦Mo≦3%, 0%≦Si≦3.5%, 0%≦Al≦4.5%, 0%≦Mn≦4.5%, 0%≦Me≦6%, where Me is one or more of the elements Sn, Zn, W, Ta, Nb, Zr and Ti, 0%≦V≦4.5%, 0%≦Ni≦5%, 0%≦C<0.05%, 0%≦Cu<1%, 0%≦P<0.1%, 0%≦N<0.5%, 0%≦0<0.05%, 0%≦B<0.01%, and the balance being essentially iron and the usual impurities.

2. A magnetic component according to claim 1, wherein 6%<Co<16%.

3. A magnetic component according to claim 1, wherein 10.5%<Co<18.5%.

4. A magnetic component according to claim 1, wherein 0.01%≦Mn≦1% and 0.005%≦S≦0.5%.

5. A magnetic component according to claim 4, wherein 0.01%≦Mn≦0.1% and 0.005%≦S≦0.05%.

6. A magnetic component according to claim 1, wherein the ratio Mn/S≧1.7.

7. A magnetic component according to claim 1, wherein the sum of Cr and Mo is 11%≦Cr+Mo≦19%.

8. A magnetic component according to claim 1, wherein the sum of Si+1.3Al+1.3Mn+1.7Sn+1.7Zn+1.3V≦3.5%.

9. A magnetic component according to claim 1, wherein the polarization J of the magnetic component at a magnetic field H of 160 A/cm is greater than 1.6 T.

10. A magnetic component according to claim 1, wherein the saturation polarization Jₛ of the magnetic component at a magnetic field H of 160 A/cm is greater than 1.7 T.

11. A magnetic component according to claim 1, wherein the saturation polarization Jₛ of the magnetic component at a magnetic field H of 600 A/cm is greater than 1.75 T.

12. A magnetic component according to claim 1, wherein the saturation polarization Jₛ of the magnetic component at a magnetic field H of 600 A/cm is greater than 1.8 T.

13. A magnetic component according to claim 1, wherein the resistivity of the magnetic component is greater than 0.4 μΩm.

14. A magnetic component according to claim 1, wherein the resistivity of the magnetic component is greater than 0.5 μΩm.

15. A magnetic component according to claim 1, wherein the resistivity of the magnetic component is greater than 0.58 μΩm.

16. A magnetic component according to claim 1, wherein The fuel injection device is for use in a gasoline engine.

17. A magnetic component according to claim 1, wherein the fuel injection device is for use in a diesel engine.

18. A magnetic component according to claim 1, wherein the fuel injection device is a direct fuel injection valve.

19. A magnetic component according to claim 1, wherein the magnetic component is for use in an environment comprising a mixture of fuel and alcohol, wherein the fuel is one of gasoline and diesel.

20. A magnetic component according to claim 19, wherein the alcohol is one of methanol, ethanol and a mixture of methanol and ethanol.

21. A magnetic component according to claim 19, wherein the mixture comprises 90% gasoline and 10% alcohol.

22. A magnetic component according to claim 19, wherein the mixture comprises 85% gasoline and 15% alcohol.

23. A magnetic component according to claim 19, wherein the mixture comprises 80% gasoline and 20% alcohol.
